(19) United States
(12) Patent Application Publication
(10) Pub. No.: US 2022/0257463 A1
(43) Pub. Date: Aug. 18, 2022

(54) Vibration Inducing Sound Mat

(71) Applicants: David Sampson, Santa Fe, NM (US); Josiah Vernon Batson, Cardiff by the Sea, CA (US)

(72) Inventors: David Sampson, Santa Fe, NM (US); Josiah Vernon Batson, Cardiff by the Sea, CA (US)

(21) Appl. No.: 17/673,777

(22) Filed: Feb. 16, 2022

Related U.S. Application Data
(60) Provisional application No. 63/150,344, filed on Feb. 17, 2021.

(51) Int. Cl. A61H 23/02

(52) U.S. Cl. CPC A61H 23/0245; A61H 2201/0165; A61H 2203/0456; A61H 2201/5005; A61H 2201/5048; A61H 2201/1207

(57) ABSTRACT

A vibration inducing sound mat apparatus includes a first panel and a second panel, wherein the first panel has a first foam layer, a second rigid layer, a third foam layer, a fourth foam layer and a fifth foam layer. The second panel has a sixth foam layer, a seventh rigid layer, an eighth foam layer, a ninth foam layer and a tenth foam layer. The second rigid layer is under the first foam layer, and above the third foam layer, the fourth foam layer, and the fifth foam layer. The seventh rigid layer is under the sixth foam layer, and above the eighth foam layer, the ninth foam layer, and the tenth foam layer. The third foam layer and the eighth foam layer preferably are softer than each of the first foam layer, the fourth foam layer, the fifth foam layer, the sixth foam layer, the ninth foam layer, and the tenth foam layer;

This application claims the benefit of the priority filing date of provisional application No. 63/150,344, entitled “Vibration Inducing Sound Mat” filed on Feb. 17, 2021, the content of which are incorporated herein by reference in its entirety.

### BACKGROUND

### Field of the Invention

The present invention relates in general to various vibrating apparatus, including vibrating support apparatus such as furniture, for supporting a user resting thereon. More specifically, the present invention relates to a vibration inducing sound mat for transmitting sound and vibration waves to a user resting thereon.

### BRIEF DESCRIPTION OF THE FIGURES

FIG. 1 illustrates an exploded bottom perspective view of first panel foam layers of a vibration inducing sound mat.

FIG. 2 illustrates an exploded bottom perspective view of second panel foam layers of the vibration inducing sound mat.

FIG. 3 illustrates a bottom plan view of a fifth layer of semi-rigid foam of the vibration inducing sound mat first panel.

FIG. 4 illustrates a top plan view of the first panel of the vibration inducing sound mat with the first layer medium density foam removed.

FIG. 5 illustrates a bottom plan view of the first panel and the second panel of the vibration inducing sound mat in an unfolded arrangement.

FIG. 6 illustrates section elevation view of a portion of the first panel having a control unit installed in a control unit cutout.

FIG. 7 illustrates a bottom plan view of the first panel and the second panel of the vibration inducing sound mat in an unfolded configuration, including transducers incorporated in the first panel and second panel.

FIG. 8 illustrates a top plan view of the vibration inducing sound mat, including the first panel and the second panel installed in a removable cover with a first layer and a sixth layer removed.

### SUMMARY

A vibration inducing sound mat apparatus is provided for a user to lay on and experience tactile vibrations of varying waveforms and varying intensity. The apparatus includes a first panel and a second panel, wherein the first panel has a first foam layer, a second rigid layer, a third foam layer, a fourth foam layer and a fifth foam layer. The second panel has a sixth foam layer, a seventh rigid layer, an eighth foam layer, a ninth foam layer and a tenth foam layer. Preferably the second rigid layer is under the first foam layer, and above the third foam layer, the fourth foam layer, and the fifth foam layer. Also preferably, the seventh rigid layer is under the sixth foam layer, and above the eighth foam layer, the ninth foam layer, and the tenth foam layer. The third foam layer and the eighth foam layer preferably are softer than each of the first foam layer, the fourth foam layer, the fifth foam layer, the sixth foam layer, the ninth foam layer, and the tenth foam layer.

A first transducer is affixed to the second rigid layer in a first transducer cutout, and a second transducer is affixed to the seventh rigid layer in a second transducer cutout. A control unit is provided, in electrical communication with the first transducer and the second transducer. The first transducer and the second transducer are configured to convert an electrical signal input to the control unit to tactile vibrations of various waveforms and intensities across the first panel and the second panel. The vibration inducing sound mat preferably also includes a cover configured to hold the first panel proximal the second panel in a folding configuration and allow them to lay flat next to one another when unfolded.

In various implementations, the first foam layer, the second rigid layer, the third foam layer, the fourth foam layer, and the fifth foam layer may all be of the same size and overlap with a common peripheral contour. Likewise, the sixth foam layer, the seventh rigid layer, the eighth foam layer, the ninth foam layer and the tenth foam layer may all be of the same size and overlap with a common peripheral contour. In one implementation, the first foam layer and the sixth foam layer are softer than each of the fourth foam layer, fifth foam layer, ninth foam layer and tenth foam layer, but firmer than the third foam layer and the eighth foam layer. In another implementation, the third foam layer may be located adjacent the second rigid layer, and the eighth foam layer may be located adjacent the seventh rigid layer.

In additional implementations, the first transducer may contact the second rigid layer in the first transducer cutout without making contact with the third foam layer, the fourth foam layer, or the fifth foam layer. Likewise, the second transducer may contact the seventh rigid layer in the second transducer cutout without making contact with the eighth foam layer, the ninth foam layer, or the tenth foam layer.

The first panel may include a control unit cutout for housing the control unit. In one implementation, the control unit cutout is formed in the third foam layer, the fourth foam layer, and the fifth foam layer of the first panel. The control unit may be mounted to the second rigid layer along with the first transducer. The control unit preferably includes controls for adjusting the intensity of the first transducer and the second transducer. The control unit may include a headphone jack for audio signal input to the apparatus and an auxiliary input for communicating electrical signal to the first transducer and the second transducer, among other features. The fifth foam layer preferably comprises a hinge portion for accessing, installing, and removing the control unit.

In other implementations, the first panel and the second panel may each comprise multiple transducers. The cover may include a first section, configured to hold the first panel, and a second section configured to hold the second panel. Preferably, the first section is separated from the second section, and may be compartmentalized by a seam in the cover. Additionally, the first section and the second section are preferably configured in a hinged relationship and overlap with a common peripheral contour when folded. The cover seam may include cuts or other features allowing wiring from the control unit to reach transducers of the second panel

In another implementation, the vibration inducing sound mat may be characterized as an apparatus for a user to lay on and experience tactile vibrations of varying waveform and varying intensity. The vibration inducing sound mat in this implementation includes a first panel having at least one first transducer, and a second panel having at least a second transducer. The first panel includes a first foam layer, a second rigid layer, a third foam layer, a fourth foam layer, and a fifth foam layer. The second panel includes a sixth foam layer, a seventh rigid layer, an eighth foam layer, a ninth foam layer, and a tenth foam layer.

In this implementation, the third foam layer is softer than the first foam layer, and the eighth foam layer is softer than the sixth form layer. Additionally, the first foam layer is softer than the fourth foam layer and the fifth foam layer, while the sixth foam layer is softer than the ninth foam layer and the tenth foam layer. A control unit is provided in a control unit cutout and is configured to send an electrical signal to the first transducer and the second transducer, thereby imparting tactile vibrations of varying waveform and intensity to the first panel and the second panel to be experienced by a user.

### DESCRIPTION

The following description is presented to enable any person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown but is to be accorded the widest scope consistent with the principles and features disclosed herein.

Referring to the above referenced figures, a vibration inducing sound mat comprises three main components: a two-panel, generally flat, foam and wood support structure (i.e., a folding mat structure, preferably suitable for supporting at least a portion of a user's body), an electronics system including transducers configured to produce and deliver vibrations, including sound vibrations, into the support structure, and a case configured for containing the support structure, folding the support structure, thus providing a portable vibration inducing sound mat.

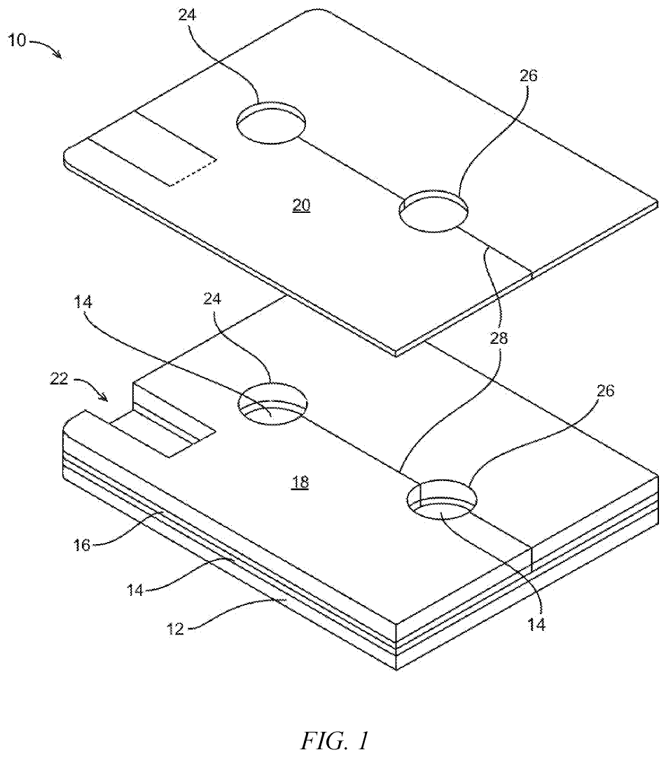

Referring to FIG. 1, a first panel 10 of a vibration inducing sound mat includes a first layer 12 comprising medium density foam, a second layer 14 which is a weight bearing layer of a rigid material such as wood (although other rigid materials comprising plastic or any other synthetic or natural rigid material is contemplated), a third layer 16 comprising soft foam, a fourth layer 18 of semi-rigid foam, and a fifth layer 20 of semi-rigid foam. All of the layers 12, 14, 16, 18, 20 preferably have the same length and width, and share a common peripheral contour (i.e., they are overlapping) and in one implementation, the layers 12, 14, 16, 18, 20 may be substantially thirty-five inches long by substantially twenty-seven inches wide, although any preferred measurements are contemplated. The layers 12, 14, 16, 18, 20 are preferavbly affixed together, including using glue and/or other adhesives.

In some implementations, the first layer 12 may be between one half (½) and one (1) inch in thickness for user comfort when resting on the vibration inducing sound mat. The second layer 14 of rigid material may be one quarter (¼) of an inch in thickness. The third layer 16 of soft foam may be one quarter (¼) or one half (½) of an inch in thickness. The fourth layer 18 of semi-rigid foam may be one and a half (1½) to one and three quarters (1¾) of an inch in thickness. The fifth layer 20 of semi-rigid foam may be one quarter (¼) of an inch in thickness. In some other implementations, the first layer 12 may be a 1.2# (1.2 pound) polyethylene laminated closed cell foam. The third layer 16 may be a 1.35# (1.35 pound) grey ether open cell foam. The fourth layer 18 may be a 1.7# (1.7 pound) polyethylene laminated closed cell foam, and the fifth layer 20 may also be a 1.7# (1.7 pound) polyethylene laminated closed cell foam. In other implementations, other types of foam and thicknesses of foam are contemplated.

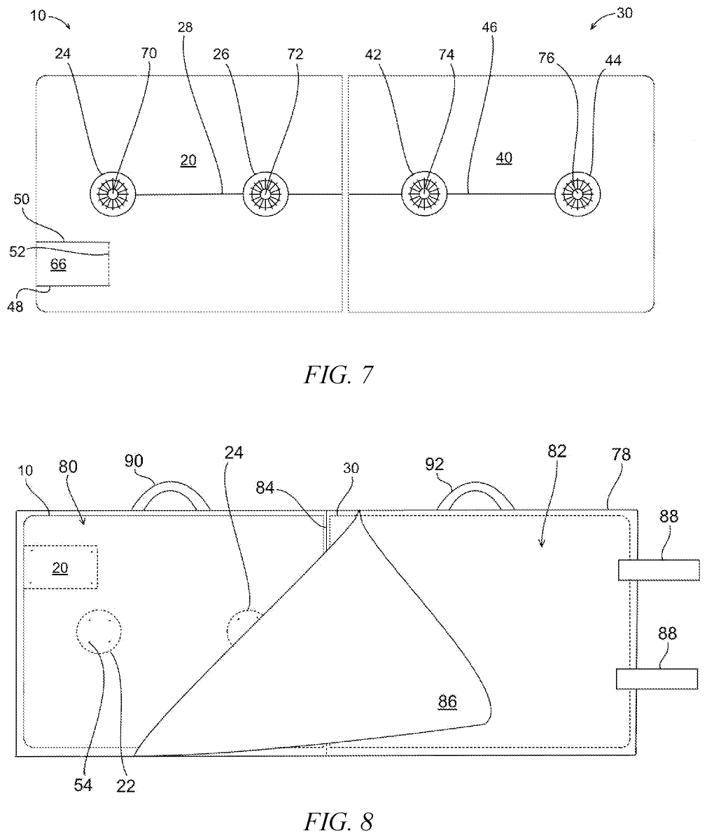

Still referring to FIG. 1, the third layer 16 and the fourth layer 18 preferably include a control unit cutout 22 for accommodating an electronics control unit 58 (FIG. 6). The third layer 16, fourth layer 18, and fifth layer 20 preferably include a first transducer cutout 24 for accommodating a first transducer 70 (FIG. 7). A second transducer cutout 26 is provided in the third layer 16, fourth layer 18, and fifth layer 20 for accommodating a second transducer 72 (FIG. 7). In some implementations, the third layer 16, the fourth layer 18, and the fifth layer 20 may include a first slot 28 to assist in creating the first transducer cutout 24 and second transducer cutout 26, as well as to allow wires to pass through the layers to power the transducers 70, 72 (FIG. 7), and reduce any tortional forces on the third layer 16, the fourth layer 18, and the fifth layer 20.

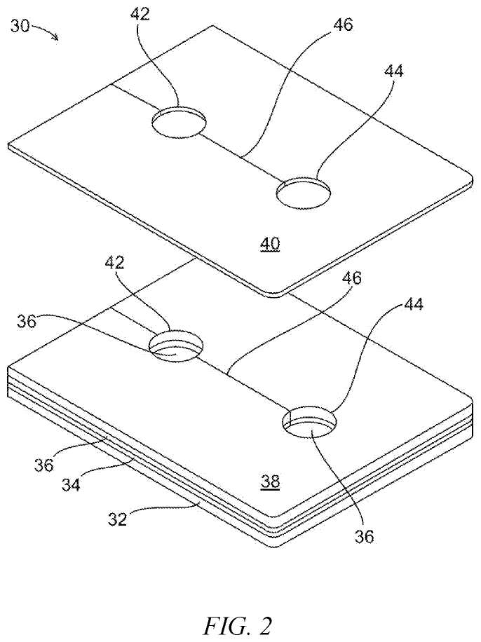

Referring to FIG. 2, a second panel 30 of a vibration inducing sound mat includes a sixth layer 32 of medium density foam, a seventh layer 34 which is a weight bearing layer of a rigid material such as wood (although other rigid materials comprising plastic or any other synthetic or natural rigid material is contemplated), an eighth layer 36 comprising soft foam, a ninth layer 38 of semi-rigid foam, and a tenth layer 40 of semi-rigid foam. All of the layers 32, 34, 36, 38, 40 preferably have the same length and width, and share a common peripheral contour (i.e., they are overlapping) and in one implementation, the layers 32, 34, 36, 38, 40 may be thirty-five inches long by twenty-seven inches wide, although any preferred measurements are contemplated. The layers 32, 34, 36, 38, 40 are preferavbly affixed together, including using glue and/or other adhesives.

In some implementations, the sixth layer 32 may be between one half (½) and one (1) inch in thickness for user comfort when resting on the vibration inducing sound mat. The seventh layer 34 of rigid material may be one quarter (¼) of an inch in thickness. The eighth layer 36 of soft foam may be one quarter (¼) of an inch in thickness. The ninth layer 38 of semi-rigid foam may be one and a half (1½) to one and three quarters (1¾) of an inch in thickness. The tenth layer 40 of semi-rigid foam may be one quarter (¼) of an inch in thickness. In other implementations, the thicknesses may be approximate values, and other thicknesses may be used as appropriate

Still referring to FIG. 2, the eighth layer 36, ninth layer 38, and tenth layer 40 preferably include a third transducer cutout 42 for accommodating a third transducer 74 (FIG. 7). A fourth transducer cutout 44 is provided in the eighth layer 36, ninth layer 38, and tenth layer 40 for accommodating a fourth transducer 76 (FIG. 7). In some implementations, the eighth layer 36, the ninth layer 38, and the tenth layer 40 may include a second slot 46 to assist in creating the third transducer cutout 42 and fourth transducer cutout 44, as well as to allow wires to pass through the layers to power the transducers 74, 76 (FIG. 7), and reduce any tortional forces on the eighth layer 36, the ninth layer 38, and the tenth layer 40. The primary difference, therefore, between the first panel 10 and the second panel 30 is the absence of a control unit cutout 22 (FIG. 1) in the second panel 30 since the control unit 58 controls all transducers in the first panel 10 (i.e., the first transducer 70 and the second transducer 72) and the second panel 30 (i.e., the third transducer 74 and the fourth transducer 76).

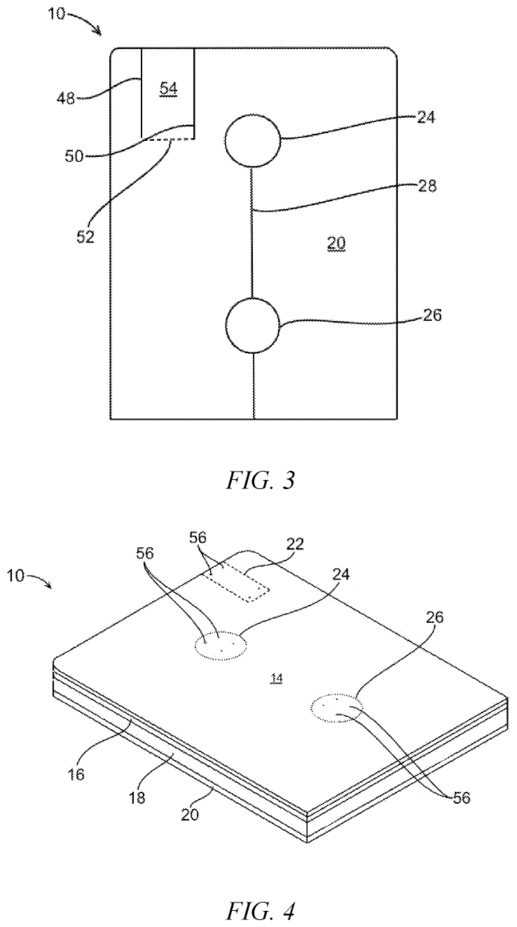

Referring to FIG. 3, a bottom view of the fifth layer 20 of semi-rigid foam of the first panel 10 is shown in plan view. The fifth layer 20 of semi-rigid foam includes a first hinge cut 48 and a second hinge cut 50. The first hinge cut 48 and the second hinge cut 50 are preferably in alignment with the control unit cutout 22 of the third layer 16 of soft foam, and the fourth layer 18 of semi-rigid foam (FIG. 1). A living hinge 52 is provided, thereby creating a flap 54 in the fifth layer 20 of semi-rigid foam, allowing access to the control unit 58 for removal, installation, or maintenance.

Referring to FIG. 4, the first panel 10 is shown, with the first layer 12 of medium foam (FIG. 1) removed to show a top view of the second layer 14 of rigid material, the third layer 16 of soft foam material, the fourth layer 18 of semi-rigid foam material, and the fifth layer 20 of semi-rigid foam material. In one implementation, the second layer 14 is a weight bearing layer, one fourth (¼) of an inch in thickness as discussed, and is preferably made of wood, MDF, plastic, or a similar relatively rigid material as discussed.

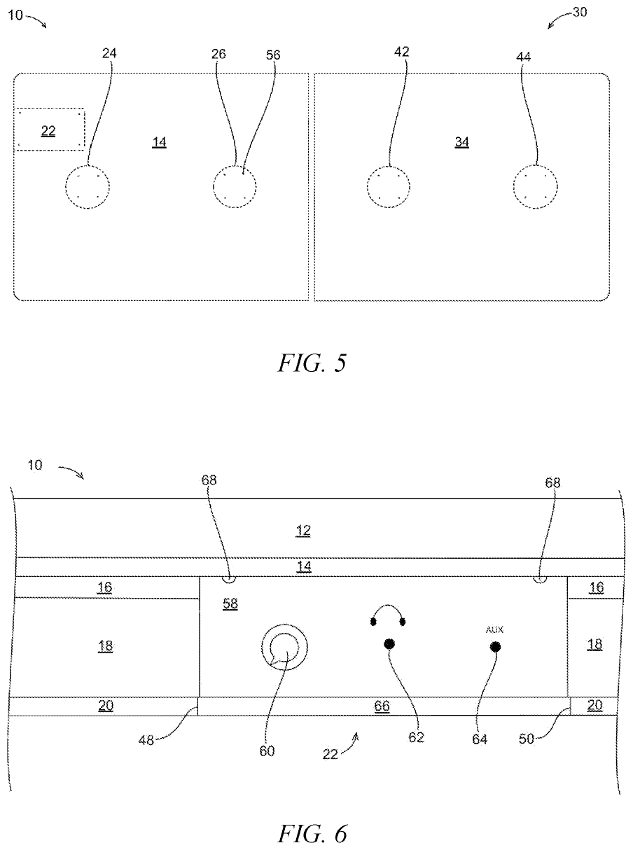

The second layer 14 may include threaded inserts 56, which in various implementations may be t-nuts, or a similar threaded fastening system. Alternatively other non-threaded fastening systems are contemplated according to preference. The threaded inserts 56 are preferably located in alignment with the first transducer cutout 24 and the second transducer cutout 26 in order to mount the first transducer 70 and second transducer 72 (FIG. 7). Threaded inserts 56 are also preferably provided in alignment with the control unit cutout 22 in the first panel 10 for mounting the control unit 58. Similar structures are provided on the second panel 30 for mounting the third transducer 74 and the fourth transducer 76 as shown in FIG. 5.

Still referring to FIG. 4, in the illustrated implementation, the second layer 14 of rigid material is preferably in peripheral contour with the first layer 12 (not shown) of medium density foam, the third layer 16 of soft foam, the fourth layer 18 of semi-rigid foam, and the fifth layer 20 of semi-rigid foam, such that they share a common peripheral edge. In a preferred implementation, the seventh layer 34 of the second panel 30 is substantially similar to the second layer 14 of the first panel 10, in terms of its dimensions, and being preferably in peripheral contour with the sixth layer 32 of medium density foam, the eighth layer 36 of soft foam, the ninth layer 38 of semi-rigid foam, and the tenth layer 40 of semi-rigid foam. Since the control unit 58 is located in the first panel 10, in most implementations, the seventh layer 34 lacks any threaded inserts 56 complimentary to the control unit 58 but includes threaded inserts 56 in alignment with the third transducer cutout 42 and the fourth transducer cutout 46 as discussed.

Referring to FIG. 5, a top view of the first panel 10 and the second panel 30, with the first layer 12 of medium density foam, and the sixth layer 32 of medium density foam removed is shown. The second layer 14 of rigid material and the seventh layer 34 of rigid material are shown in an open, unfolded, mat-like configuration, in which a user would be able to lay across the first layer 12 of medium density foam (not shown) and the sixth layer 32 of medium density foam (not shown) when the vibration inducing sound mat is in use. In the open configuration, as shown from above, the first second layer 14 of rigid material, and the seventh layer 34 of rigid material are shown on the first panel with the threaded inserts 56 aligned with the first transducer cutout 24, the second transducer cutout 26, and the control unit cutout 22, while on the second panel 30, the threaded inserts 56 are aligned with the third transducer cutout 42 and the fourth transducer cutout 44.

Referring to FIG. 6, a portion of the first panel 10 is shown in elevation view, including the control unit cutout 22 in which a control unit 58 is installed. The control unit 58 preferably includes a potentiometer 60 for governing the intensity and optionally, the waveforms of vibrations produced by the transducers 70, 72, 74, 76 (FIG. 7). In one implementation, the control unit 58 also includes a headphone connector 62 enabling a user to connect headphones (not shown) and listen to an audio signal that may coincide with the vibratory signal transmitted to the transducers 70, 72, 74, 76. An auxiliary input 64 may also be provided for inputting an audio or other signal to the control unit and the transducers 70, 72, 74, 76, enabling a user to customize the waveforms emitted by the transducers 70, 72, 74, 76.

The fifth layer 20 of semi-rigid foam includes a hinge portion 66 formed by the first hinge cut 48 and the second hinge cut 50. The hinge portion 66 is shown in a lowered position over the control unit 58. The hinge portion 66 may be raised to install and remove the control unit 58 as desired. In the illustrated implementation, the control unit 58 is affixed to the second layer 14 of rigid material using fasteners 68 to engage the threaded inserts 54 (not shown) in the second layer 14 of rigid material in alignment with the control unit cutout 22.

Referring to FIG. 7, a bottom view of the first panel 10 and the second panel 30 of the vibration inducing sound mat is shown. The first panel includes the first transducer 70 installed in the first transducer cutout 24 and the second transducer 72 installed in the second transducer cutout 26. The second panel 30 includes the third transducer 74 installed in the third transducer cutout 42, and the fourth transducer 76 installed in the fourth transducer cutout 44. In one preferred implementation, the first transducer 70 and the second transducer 72 are mounted to the second layer 14 (FIG. 5), and the third transducer 74 and fourth transducer 76 are mounted on the seventh layer 34 (FIG. 5). In another preferred implementation, the first transducer 70 and the second transducer 72 are configured so that they are lower in profile than the fifth layer 20 of semi-rigid foam material (i.e., they are recessed inward from the fifth layer 20) to prevent any contact with any surface the first panel 10 is laying on. Likewise, the third transducer 74 and the fourth transducer 76 are configured so they are lower in profile than the tenth layer 40 of semi-rigid foam material (i.e., they are recessed inward from the tenth layer 40) to prevent any contact with any surface the second panel 30 is laying on.

The first transducer 70, second transducer 72, third transducer 74, and fourth transducer 76 are each electronically coupled to the control unit 58 (FIG. 6) which is installed on the second layer 14 and under the fifth layer 20 of semi-rigid foam material, under the hinge portion 66 in the control unit cutout 22. Since the transducers 70, 72, 74, 76 are recessed in the transducer cutouts 24, 26, 42, 44, respectively, and because the control unit 58 is covered by the hinge portion 66, users may lay across the first panel 10 and the second panel 30 with their weight across the first layer 12 of medium density foam and sixth layer 32 of medium density foam without contacting the transducers 70, 72, 74, 76, or the control unit 58.

In both the first panel 10 and the second panel 30, the relatively resilient semi-rigid foam of the fourth layer 18 and fifth layer 20 (of the first panel 10) and the ninth layer 38 and tenth layer 40 (of the second panel 30) (and the first transducer cutout 24, second transducer cutout 26, third transducer cutout 42, and fourth transducer cutout 44 therein) ensure that space is maintained around the first transducer 70 and second transducer 72, which are preferably fixed only to the second layer 14 of rigid material, and the third transducer 74 and fourth transducer 76, which are preferably fixed only to the seventh layer 34 of rigid material. By isolating the transducers 70, 72, 74, 76 in open space without contacting any of the foam layers 16, 18, 20, 36, 38, 40 (or other structures), the transducers 70, 72, 74, 76 impart vibrations primarily to the second layer 14 and seventh layer 34 of rigid material. Thus, the vibrations imparted by the transducers 70, 72, 74, 76 when active, are generalized over the entire first panel 10 and second panel 30, rather than being localized at the transducers 70, 72, 74, 76.

Additionally, by incorporating the third layer 16 of soft foam material between the rigid second layer 14 and the semi-rigid foam fourth layer 18 (and by incorporating the eighth layer 36 of soft foam material between the rigid seventh layer 34 and the semi-rigid foam ninth layer 38), different waveforms of electro-acoustic and/or vibratory waves generated by the transducers 70, 72, 74, 76 can be more readily tactilely detected by a user (i.e., subtle changes in the nature of vibrations produced can be discerned by a user). This is because the soft foam third layer 16 and the soft foam eighth layer 36, being relatively soft relative to adjacent layers, provides a buffer zone between the second layer 14 and the seventh layer 34 of rigid material, and the user.

The control unit 58 (FIG. 6) and vibration inducing tactile transducers 70, 72, 74, 76 are affixed to the second layer 14 and the seventh layer 34, preferably in a manner such that vibrations produced by the transducers 70, 72, 74, 76 are transferred to the second layer 14 and the seventh layer 34 with little energy loss. The control unit 58 may include an amplification unit (not shown) with a wireless receiver to power the transducers 70, 72, 74, 76. In alternative implementations, the amplification unit may be separate from the control unit 58. In one implementation, the amplification unit may be configured for outputting sound to headphones. In another implementation, a rechargeable power supply (e.g., a battery) (not shown) may be provided for powering the amplification unit and/or the transducers 70, 72, 74, 76.

The control unit 58 and transducers 70, 72, 74, 76 may be arranged in any pattern on the second layer 14 and seventh layer 34. Although four transducers 70, 72, 74, 76 are shown in the illustrated implementation, in various other implementations, there may be more, or fewer transducers attached to each of the second layer 14 and seventh layer 34 of rigid material. In the illustrated implementation, there are two transducers attached per panel (i.e., first transducer 70 and second transducer 72 in the first panel 10, and third transducer 74 and fourth transducer 76 in the second panel 30).

The transducers 70, 72, 74, 76 are preferably wired in stereo and can be arranged in a LLRR pattern, LRRL pattern, LRLR pattern, or other patterns according to preference. The transducers 70, 72, 74, 76 may be electronically connected to the amplification unit (not shown), which powers the transducers 70, 72, 74, 76 preferably stereophonically and/or stereovibrationally. As discussed above, the amplification unit also preferably includes a headphone amplifier. In various implementations, the amplification unit may be configured to receive wireless audio signals, such as from WIFI®, BLUETOOTH®, or other similar wireless data transmission source. The amplification unit may also be configured to receive audio through traditional output sources such as 1/8-inch stereo cable, ¼-inch stereo cable, phono plugs, xls cable, etc. The amplification unit is preferably powered by an internal or external battery, or alternatively by an external power source.

Referring to FIG. 8 in one preferred implementation, the first panel 10 and the second panel 30 are enclosed in a cover 78 (the first layer 12 and the sixth layer 32 of medium density foam are omitted for clarity). The cover 78 is configured to also house any electronics related to the control unit 58 and additional structures for power supply and/or amplification. The cover 78 includes a first section 80 for housing the first panel 10, and a second section 82 for housing the second panel 28. A seam 84 or similar structure may be provided for keeping the first panel 10 separate from the second panel 30, to compartmentalize them, and to arrest undue movement of the first panel 10 and second panel 30 in the cover 78. Preferably the cover 78, including the seam 84, is configured to allow electronics for powering the third transducer 74 and fourth transducer 76 in the second panel 30 to extend from the control unit 58 across the cover 78 to the second section 82 to reach the second panel 30.

The cover 78 preferably includes an openable flap 86, for installing and removing the first panel 10 and second panel 30 and related structures, and to allow access to them as desired. The seam 84, and the first section 80 and second section 82 are preferably configured such that when the first panel 10 and second panel 30, and related structures are enclosed in the cover 78, the cover 78 can be folded, functioning as a hinge that connects the first panel 10 and the second panel 30 in a hinged arrangement, and unfolded to the vibration inducing sound mat configuration for use.

In one implementation, the cover 78 also includes one or more closure straps 88 for securing the apparatus in a folded configuration for transport and/or storage. In the illustrated implementation, two hook and latch (i.e., VELCRO®) closure straps 88 are shown, although any closure mechanisms that effectively secure the vibration inducing sound mat in a folded configuration are contemplated. Preferably, a first handle 90 and a second handle 92 are provided near the first section 80 and the second section 82, respectively. The first handle 90 and the second handle 92 are preferably positioned such that when the vibration inducing sound mat is folded, they come together for convenient, single-handed cartage. The cover 78 preferably includes a portal (not shown) for accessing the control unit 58 when the cover 78 is closed and the vibration inducing sound mat is in use. The cover 78 is preferably made of sturdy weather resistant material, and in one implementation, may include a hole and pouch for a battery (not shown) or similar power source.

In order to use the vibration inducing sound mat, from a folded configuration, a user may carry the apparatus using the first handle 90 and second handle 92, with the cover 78 folded and secured using the one or more closure straps 88. The user unfastens the closure straps 88 and unfolds the cover 78, placing the apparatus on a flat surface with the first layer 12 and sixth layer 32 of medium density foam (of the first panel 10 and second panel 30, respectively) facing upward. The user may then connect a signal source and power, if needed, to the apparatus. Electronic signals from the source are fed through the control unit 58 and are transmitted to the transducers 70, 72, 74, 76. The transducers 70, 72, 74, 76 convert the signal to vibrations of varying waveforms and intensities, which are absorbed by the second layer 14 and the seventh layer 34, and are emitted through the first layer 12, third layer 16, fourth layer 18, fifth layer 20, sixth layer 32, eighth layer 34, ninth layer 36, and tenth layer 40, where they are tactilely detected by the user. The user may also plug headphones into the control unit 58 to listen along to audio signal, which may correspond to the signal transmitted to the transducers 70, 72, 74, 76.

In other implementations, it is anticipated that the sound mat may be configured or incorporated into different forms that lay on the ground (e.g., such as a single, non-folding, sheet, optionally having the same dimensions), or may be configured as a floating vibrating floor.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A vibration inducing sound mat apparatus for a user to lay on and experience tactile vibrations, the apparatus comprising:
a first panel and a second panel
the first panel comprising a first foam layer, a second rigid layer, a third foam layer, a fourth foam layer, and a fifth foam layer;
the second panel comprising a sixth foam layer, a seventh rigid layer, an eighth foam layer, a ninth foam layer, and a tenth foam layer;
wherein the second rigid layer is under the first foam layer, and above the third foam layer, the fourth foam layer, and the fifth foam layer;
wherein the seventh rigid layer is under the sixth foam layer, and above the eighth foam layer, the ninth foam layer, and the tenth foam layer;
a first transducer affixed to the second rigid layer in a first transducer cutout;
a second transducer affixed to the seventh rigid layer in a second transducer cutout;
a control unit in electrical communication with the first transducer and the second transducer;
wherein the third foam layer and the eighth foam layer are softer than each of the first foam layer, the fourth foam layer, the fifth foam layer, the sixth foam layer, the ninth foam layer, and the tenth foam layer; and
wherein the first transducer and the second transducer are configured to convert an electrical signal input to the control unit to tactile vibrations across the first panel and the second panel.

2. The apparatus of claim 1 further comprising a cover configured to hold the first panel proximal the second panel in a folding configuration.

3. The apparatus of claim 1 wherein the first foam layer, the second rigid layer, the third foam layer, the fourth foam layer and the fifth foam layer all overlap in peripheral contour.

4. The apparatus of claim 1 wherein the sixth foam layer, the seventh foam layer, the eighth foam layer, the ninth foam layer, and the tenth foam layer all overlap in peripheral contour.

5. The apparatus of claim 1 wherein the first foam layer and the sixth foam layer are softer than each of the fourth foam layer, fifth foam layer, ninth foam layer, and tenth foam layer.

6. The apparatus of claim 1 wherein the third foam layer is located adjacent the second rigid layer.

7. The apparatus of claim 1 wherein the eighth foam layer is located adjacent the seventh rigid layer.

8. The apparatus of claim 1 wherein the first transducer contacts the second rigid layer without contacting the third foam layer, fourth foam layer, or fifth foam layer.

9. The apparatus of claim 1 wherein the second transducer contacts the seventh rigid layer without contacting the eighth foam layer, the ninth foam layer, or the tenth foam layer.

10. The apparatus of claim 1 wherein the first panel comprises a control unit cutout for housing the control unit.

11. The apparatus of claim 10 wherein the control unit cutout is formed in the third foam layer, and the fourth foam layer.

12. The apparatus of claim 1 wherein the control unit is mounted to the second rigid layer.

13. The apparatus of claim 1 wherein the control unit comprises controls for adjusting transducer intensity.

14. The apparatus of claim 1 wherein the control unit comprises a headphone jack for audio signal input to the apparatus.

15. The apparatus of claim 1 wherein the control unit comprises an auxiliary input for communicating electrical signal to the first transducer and the second transducer.

16. The apparatus of claim 1 wherein the fifth foam layer comprises a hinge portion for accessing the control unit.

17. The apparatus of claim 1 wherein the first panel and the second panel each comprise multiple transducers.

18. The apparatus of claim 2 wherein the cover comprises a first section configured to hold the first panel and a second section configured to hold the second panel, the first section being separate from the second section.

19. The apparatus of claim 18 wherein the first section and the second section are configured in a hinged relationship and overlap when folded.

20. A vibration inducing sound mat apparatus for a user to lay on and experience tactile vibrations, the apparatus comprising:
a first panel comprising at least a first transducer;
the first panel having a first foam layer, a second rigid layer, a third soft foam layer, a fourth semi-rigid foam layer, and a fifth semi-rigid foam layer;
a second panel comprising at least a second transducer;
a second panel having a sixth foam layer, a seventh rigid layer, an eighth soft foam layer, a ninth semi-rigid foam layer, and a tenth semi-rigid foam layer;
wherein the third foam layer is softer than the first foam layer, and the eighth soft foam layer is softer than the sixth foam layer;
wherein the first foam layer is softer than the fourth foam layer and the fifth foam layer, and the sixth foam layer is softer than the ninth foam layer and the tenth foam layer; and
a control unit configured to send an electrical signal to the at least one first transducer and the at least one second transducer, thereby imparting tactile vibrations to the first panel and the second panel.
